(19) United States
(12) Patent Application Publication
(10) Pub. No.: US 2010/0218689 A1
(43) Pub. Date: Sep. 2, 2010

(54) Screen for deep fat fryers

(76) Inventor: Chad A. Mickelson, La Cross, WI (US)

Correspondence Address: DALLEY LAW FIRM, S.C., 1138 BLUESTEM COURT, ELKHOM, WI, 53121, US

(21) Appl. No.: 12/380,576

(22) Filed: Feb. 27, 2009

(51) Int. Cl. A47J 37/12; B23P 19/04

(52) U.S. Cl. 99/408; 29/700

(57) ABSTRACT

The specification relates to the commercial preparation of fried foods. Debris from the fried food sloughs off the batter or coating and remains in the fry pot and bum. The burnt food imparts off tastes to the food and decreases the service life of the fry oil. Furthermore, the debris block discharge port of the fry pot making it difficult to change the fry oil and can present a safety hazard. The present invention provides a means to reduce the amount of debris remaining in the fry oil after every fry load. Thus lengthening the service life of the fry oil and preventing clogging of the discharge port.

### BACKGROUND OF THE INVENTION

Fried foods remain a popular menu item in restaurants. This invention concerns the improvement in the frying process used in restaurants and other commercial or non-household fried food preparation. In most fried food dishes some form of starch is used in the recipe, for example potatoes for French fries; breading for fried chicken or vegetables; cornmeal for hush puppies, or rice flower for Asian foods. Regardless of the type of starch used, all fried food recipes share the same problem in frying. The problem being starchy pieces of the fried item breaking off while cooking and remaining in the fry pot after the cooked item is removed. These pieces of food burn and as the concentration burnt pieces increases, they impart off flavors to the food. In addition, the burnt particles reduce the service life of the oil. It is known in the art that removing pieces from the oil increases the service life of the oil, but current devices are less than satisfactory to the restaurateur.

### SUMMARY OF THE INVENTION

Generally commercial fryers have built in filter systems or an auxiliary filter system is used to filter the fry oil. However, use of these systems is limited by the amount of time necessary to complete the filtering operation. The filtering operation can take as long as half hour. During which time the fryer is out operation. Forcing the restaurateur to purchase a second fryer, or absorb the down time as an operational expense. In any case, filtering after each load is impractical.

Other methods place a pre-filter made of a fine mesh in the cold well of fry pot. The pre-filter is then removed prior to filtering or can be removed and emptied after each load. The device in unacceptable because a separate griper must be used to reach into the cold well in the bottom of the fry pot, then articulated to grasp the pre-filter assembly, and then pull the assembly out of the fry pot, and then emptied, and returned to the cold well. The device is unacceptable because of the difficulty in manipulating the griper. In addition, very unsafe condition can be created if the gripper slips causing the pre-filter assembly to fall back into pot and thereby splashing the hot oil on the operator causing a severe burn. To prevent injury, the operator must don protective equipment to prevent being burned in case the pre-filter slips from the griper.

The present invention screens the food particles from the hot oil with the same ease and simplicity of using the fry basket. By placing a sheet metal screen underneath the fry baskets and above the heater in the fry pot with handle and shaft attached to the screen; the screen can be removed after every load, or as needed by the fryer operator. By practicing the invention the restaurateur gains the benefit of increased service life for the fly oil by removing the particles of food and improved safety when draining the oil. In addition to decreasing the service life of the fry oil, the food particles often partially block the drain ports of the fry pot, causing spraying when the pot is drained. Being able to easily and conveniently remove the food particles, the partial blockage is eliminated.

### BRIEF DESCRIPTION OF THE DRAWINGS

FIG. 1 is a perspective view of the invention.

FIG. 2 describes how to practice the invention using an open top fryer.

### DESCRIPTION OF THE PREFERRED EMBODIMENT

The following provides a description of the preferred embodiment of the invention, but in no way limits the invention. Other configurations are possible. This is especially true because the invention's outer dimension must be in the same shape as the opening of the fry pot for an open top fryer.

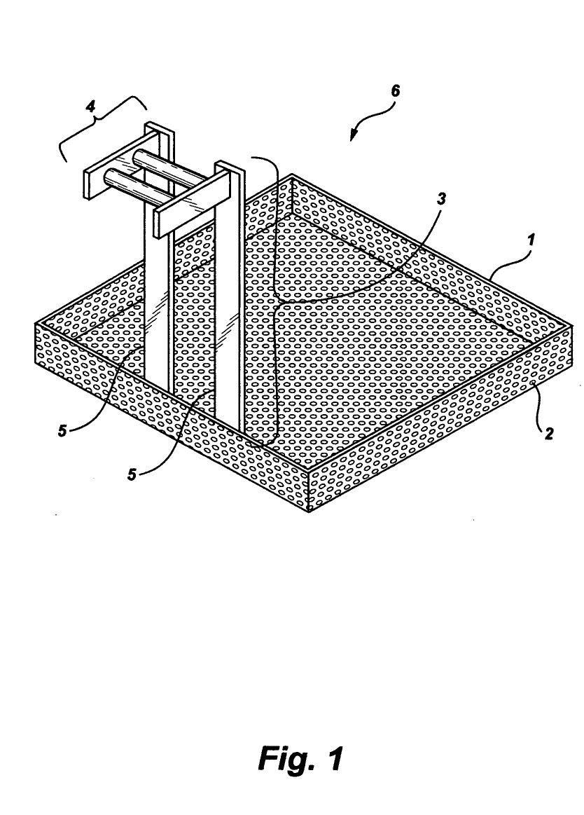

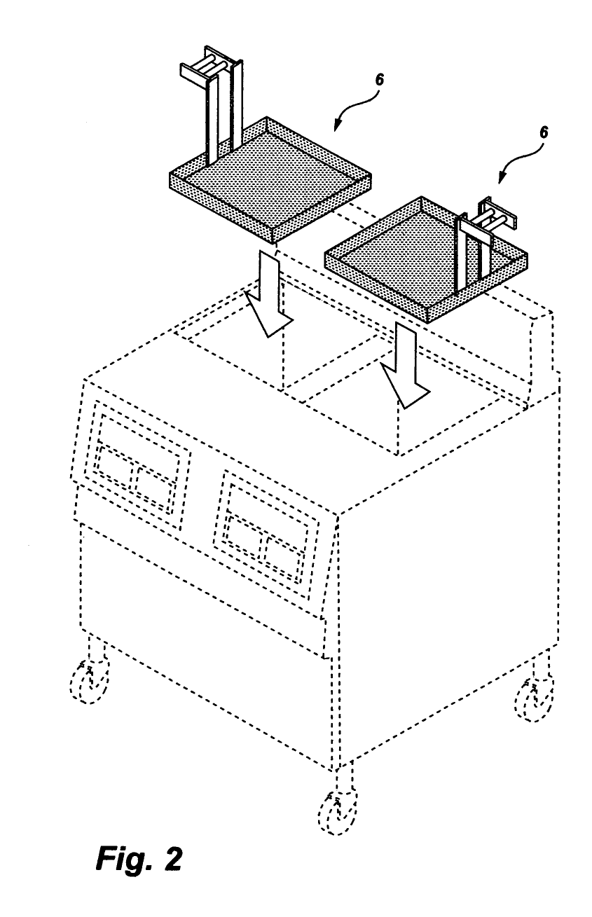

The Fryer Screen 6 comprises a metal sheet 1 with a plurality of holes 2. The holes 2 must be narrow so as to allow the fryer oil to easily drain, and at the same time catch chunks of food debris. In the embodiment described in FIG. 1, the outer dimensions of the metal 1 sheet are defined by length and width. The length and width of the metal sheet 1 should approximate the length and width of the fryer pot; and the length and width must be less than inner dimension of the fry pot. Allowing the invention to be readily placed into and removed from the fry pot, as shown in FIG. 2. In the embodiment described in FIG. 1, edges of the metal sheet 1 are folded to a given height to from an open top box. The folded edges help to retain the collected food debris and aid in emptying the screen.

Attached to the metal sheet 1 is a handle 3. The handle 3 is attached to the metal sheet 1 at one edge by means of two shafts 5. At the opposite end of the two shafts 5, a gripping member 4 is attached. The gripping member allows the operator to safely grasp and manipulate the Fryer Screen 6. Having set forth the general nature and specific embodiment(s) of the invention, the true scope is now particularly pointed out in the appended claims.

What is claimed is:

1. A fryer screen comprising: a metal sheet of any given thickness having four edges that define the outer dimension of said sheet; and wherein said outer dimension is less than and in the same shape of the inner dimension of an open fryer fry pot; and
a. wherein said metal sheet has a plurality of holes that pass through said metal sheet of sufficient diameter to allow oil to drain but to catch food debris; and
b. a handle attached to one edge of said metal sheet further comprising at least one shaft shaft having a first end and a second end and of any length that is greater than the depth of the open fryer fry pot; and wherein said first end of said shaft is attached to one edge of said metal sheet and a gripping member is attached to said second of said shaft.

2. The fryer screen of claim 1 wherein said metal sheet and said handle are made of stainless steel.

3. A method for extending the useful life of cooking oil by placing the fryer screen of claim 1 or claim 2 into the inner dimension of said open fryer fry pot, frying at least three loads of food, and removing said fryer screen emptying the fryer screen by discarding the food debris collected on said fryer screen and returning said fryer screed to said open fryer fry pot.
